(19) United States
(12) Patent Application Publication
(10) Pub. No.: US 2011/0059313 A1
(43) Pub. Date: Mar. 10, 2011

(54) DEPOSITION PROCESS

(76) Inventor: Gianpaolo Girardello, Castelfranco Veneto (TV) (IT)

(21) Appl. No.: 12/809,819

(22) PCT Filed: Dec. 18, 2008
(86) PCT No.: PCT/IB08/03552

§ 371 Date: Nov. 19, 2010

(30) Foreign Application Priority Data
Dec. 21, 2007 (IT) VR2007A000195

(51) Int. Cl. B32B 15/00; C23C 4/06

(52) U.S. Cl. 428/336; 428/457; 427/294; 427/455

(57) ABSTRACT

A deposition process includes placing a substratum to be covered in a deposition environment in which the deposition pressure is lower that the atmospheric pressure. The substratum to be covered is purified. A coating of metal material is applied in a nebulized state onto the substratum to be covered, so as to obtain a covered substratum.

### TECHNICAL FIELD OF THE INVENTION

This invention relates to a deposition process adapted to deposit in a permanent way one or more layers of metal materials, particularly precious metal materials such as gold and silver, onto substrata of a different nature.

### RELATED ART

Since ancient times, the application of laminas of metal materials, even precious, has been known, on substrata normally, but not exclusively, of a flexible nature, with the object of partially or totally coating them to make them stronger and more precious.

According to the ancient art, the metal material, e.g., gold, was subjected to many processing cycles comprising the repeated beating of the material in order to render it a very thin malleable sheet which could be shaped according to need and applied to the substratum to which it was intended for.

The application of layers of precious materials onto flexible objects such as hide without the risk of cracking is known in the Japanese patent 11129392, in which hide is covered with a layer of gold, at the same time laminating the hide with a film of soft plastic material together with a metal gold film. A further example of the application of gold metal films is found in the U.S. Pat. No. 1,547,663, in which gold films are applied cold onto hide by means of an embossing process.

A further example of the application of a layer of metal material to a hide substratum is found in the European patent application no. EP 1.500.711, which relates to a “process for the coating of hide or the like”.

According to this EP patent application, a thermo-spraying technique is used, commonly referred to as “plasma spray”, to apply layers of metal materials, mainly precious metals such as gold and silver, which are reduced to a molten state and conveyed against the substratum to be covered by means of a plasma current whose free electrons, ionized atoms and neutral atoms are accelerated using a voltaic arc generated between an anode and a cathode appropriately shaped.

According to this EP patent application, the hide surface to be covered is also cleaned in advance using a luminous discharge. This prior art has a number of drawbacks.

A first drawback is that over time, the layer of metal material applied on the hide substratum tends to form cracks due to the flexibility thereof and, as a consequence, to peel off, causing an unpleasant appearance of the applied covering. A second drawback is that the layer of metal material applied using the known arts tends to become opaque over time, drastically compromising the appearance of the substratum which is due to this application. A third drawback lies in the fact that the known methods for the application of a layer of metal onto a hide substratum are substantially complex and expensive.

A fourth drawback is that, despite cleaning phases of the substratum are provided prior to the deposit of the layer of metal material, these phases are not of proven effectiveness, and many impurities remain stuck to the hide substratum, reducing the force of aggregation between the latter and the layer of applied metal material.

### SUMMARY

One object of this invention is to improve the prior art.

Another object of this invention is to develop a deposition process which ensures the satisfactory cleaning of the substratum onto which a layer of metal material has to be applied.

A further object of this invention is to develop a deposition process by means of which a layer of metal material may be deposited onto substrata of any nature whatsoever.

A further object of this invention is to develop a deposition process which is substantially simple and cheap.

According to one aspect of the invention, a deposition process is provided, comprising the following phases: placing a substratum to be covered in a deposition environment in which the deposition pressure is lower than the atmospheric pressure; applying a coating of metal material in the nebulized state onto said substratum to be covered, so as to obtain a covered substratum characterized by the fact that before said application said substratum to be covered is purified of all impurities.

The process for the permanent deposition of nebulized metal materials allows the stabilization of the application of nebulized metal materials onto substrata of any kind and consistency, whatever the thickness of the layer of metal material deposited.

### DETAILED DESCRIPTION OF PREFERRED EMBODIMENTS

A substratum of any nature, whether rigid or flexible, onto which a layer of coating metal material is to be deposited, is placed in a first environment, such as, e.g., a first vacuum chamber, and in this first environment, having been isolated from the outside, the pressure is reduced, compared to the atmospheric pressure, to a pre-set value, defined as the purification pressure value. Indicatively, this purification pressure value is between 10⁻² bar and 10⁻³ bar and it is less than 2.5×10⁻² bar.

The substratum is maintained inside this first environment for a period of time that varies depending on the nature of the substratum being treated. It has been seen that the best results were obtained by keeping a hide substratum inside this first environment for a period of time between 12 and 14 hours, a wooden substratum for a period of time between 4 and 13 hours, a fabric substratum for a period of time between 1 and 7 hours. During this time, the impurities present in the substratum are extracted due to the force of aspiration given by the purification pressure.

When the substratum has completed the purification phase, the first environment is brought back to atmospheric pressure and the substratum is removed from the first environment, appropriately purified of impurities, and is then placed in a second environment, e.g., a second vacuum chamber, which is temporarily maintained at atmospheric pressure.

When the purified substratum is placed in the second environment, the second environment is isolated from the outside and a pressure value is created inside which is lower than the purification pressure value, defined as deposition pressure. Indicatively, the deposition pressure value created inside the second environment is between 10⁻⁴ bar and 10⁻³ bar and it is less than 5×10⁻⁴ bar.

The substratum is maintained inside this second environment at the deposition pressure for a period of time between 15 minutes and 40 minutes and approximately 35 minutes. Inside this second environment, a device is mounted which melts and nebulizes a charge of metal to be applied onto the substratum. The applying of said metal coating is at a temperature lower than 60 degrees.

This device is generally composed of a so-called “Magnetron”, and the metal which is melted and nebulized with this device is deposited on the substratum through the deposition pressure present in the second environment, to form a substantially uniform surface layer on the substratum.

The deposition phase can also be facilitated by introducing a stable chemical element into the second environment, such as a noble gas, preferably Argon. Having completed the deposition phase, also the second environment is brought back to atmospheric pressure and the substratum is removed from this second environment.

After the returning back to the atmospheric pressure, it is provided to check the organoleptic and/or mechanical parameters of said coated substratum. The coated substratum has no-peelable metal constant thickness, that is over or equal to 50 nanometers. The purification environment and the deposition environment are separated from each other or they coincide.

According to the deposition process, an optional procedure can be used depending on the nature of the substratum which, in order to maintain the layer of metal material applied to the substratum unaltered, provides the application of a protective covering layer of a resin-based material, such as, e.g., a bi-component polyurethane resin. Again according to the deposition process, it is provided, if required, to delimit some areas of the substratum with delimination means, so as to obtain delimited purification and/or deposition areas onto which the melted and nebulized metal material is to be applied.

The deliminating comprises covering at least temporarily perimeter areas of said delimited deposition areas of said substratum with said delimination means. Between said purifying and said applying it is provided to coat at least said delimited deposition areas with a layer of covering material. Said coating comprises lacquering, spreading, nebulizing, painting. Adhesive material, e.g., an adhesive tape, is used to delimit these areas, which can be shaped to fit around the perimeter of the areas to be delimited.

1. Deposition process comprising the following phases:
placing a flexible or rigid substratum to be covered in a deposition environment in which a deposition pressure is lower than atmospheric pressure;
applying a coating of metal material onto said substratum to be covered, so as to obtain a covered substratum, such that prior to said applying it is provided to purify said substratum to be is to covered of all impurities, by subjecting said substratum to be cover d to a purification pressure between 10⁻² bar and 10⁻³ bar, and by the fact that said applying comprises applying said metal coating at a temperature lower than 60 degrees.

2. (canceled)

3. Process as claimed in claim 1, wherein said purifying comprises placing said substratum to be covered in a purification environment where a purification pressure is present.

4. Process as claimed in claim 2, wherein said purification environment and said deposition environment are separated from each other.

5. Process as claimed in claim 2, wherein said purification environment and deposition environment coincide.

6. Process as claimed in claim 1, wherein said coating has a thickness which is over or equal to 50 nanometers.

7. Process as claimed in claim 1, wherein prior to said placing it is provided to delimit preset areas of said substratum with delimitation means, so as to obtain delimited purification and/or deposition areas.

8. Process as claimed in claim 7, wherein said delimiting comprises covering at least temporarily perimeter areas of said delimited deposition areas of said substratum with said delimitation means.

9. Process as claimed in claim 1, wherein between said purifying and said applying it is provided to coat at least said delimited deposition areas with a layer of covering material.

10. Process as claimed in claim 9, wherein said coating comprises lacquering.

11. Process as claimed in claim 9, wherein said coating comprises spreading.

12. Process as claimed in claim 9, wherein said coating comprises nebulizing.

13. Process as claimed in claim 9, wherein said coating comprises painting.

14. Process as claimed in claim 1, wherein said deposition pressure is between 10⁻⁴ bar and 10⁻³ bar.

15. (canceled)

16. Process as claimed in claim 1, wherein said subjecting comprises subjecting a substratum in natural and/or synthetic hide to said purification pressure for a period of time between 12 hours and 14 hours.

17. Process as claimed in claim 1, wherein said subjecting comprises subjecting a substratum in natural and/or synthetic fabric to said purification pressure for a period of time between 1 hour and 7 hours.

18. Process as claimed in claim 1, wherein said subjecting comprises subjecting a wooden substratum to said purification pressure for a period of time between 4 hours and 13 hours.

19. Process as claimed in claim 1, wherein said applying comprises applying for a period of time between 15 minutes and 40 minutes.

20. (canceled)

21. Process as claimed in claim 1, claims, wherein before and/or during said applying, introducing a substantially stable chemical element into said first environment.

22. Process as claimed in claim 21, wherein said substantially stable chemical element comprises a noble gas.

23. Process as claimed in claim 22, wherein said noble gas comprises Argon.

24. Process as claimed in claim 3, further comprising returning said purification environment and deposition environment back to the atmospheric pressure.

25. Process as claimed in claim 22, wherein returning back includes checking organoleptic and/or mechanical parameters of said coated substratum.

26. Process as claimed in claim 1, wherein the metal coating is applied in the nebulized state.

27. Coated substratum obtainable with a process as claimed in claim 1, comprising one flexible or a rigid substratum, providing to said substratum, prior to the coating, a purification from all impurities by subjecting said substratum to be covered to a purification pressure between 10⁻² bar and 10⁻³ bar and applying said metal coating at a temperature lower than 60 degrees, such that it has a no-peelable metal coating.

28. Substratum as claimed in claim 27, wherein said metal coating has a substantially constant thickness.

29. Substratum as claimed in claim 27, wherein said metal coating has a thickness over or equal to 50 nanometers.

30. (canceled)

31. (canceled)
